(19) United States
(12) Patent Application Publication
(10) Pub. No.: US 2018/0282562 A1
(43) Pub. Date: Oct. 4, 2018

(54) Water-Based Ink for Ink-Jet Recording and Ink Container

(71) Applicant: Brother Kogyo Kabushiki Kaisha, Nagoya-shi (JP)

(72) Inventors: Satoshi Okuda, Inazawa-shi (JP); Akihiko Taniguchi, Kakamigahara-shi (JP); Mitsunori Maeda, Nagoya-shi (JP); Yuka Tsuzaka, Nagoya-shi (JP)

(21) Appl. No.: 15/882,434

(22) Filed: Jan. 29, 2018

(30) Foreign Application Priority Data
Mar. 31, 2017 (JP) 2017-071135

(51) Int. Cl. C09D 11/322; C09D 11/326; C09D 11/324; C09D 11/037; C09D 11/107; C09D 11/108

(52) U.S. Cl. CPC C09D 11/322; C09D 11/326; C09D 11/324; C08K 3/04; C09D 11/107; C09D 11/108; C08K 2201/003; C09D 11/037

(57) ABSTRACT

There is provided a water-based ink for ink-jet recording including: a self-dispersible pigment of which mean particle diameter is not less than 130 nm; a resin-dispersed pigment; and water; wherein the mean particle diameter of the self-dispersible pigment is in a range of 1.5 times to 3 times mean particle diameter of the resin-dispersed pigment.

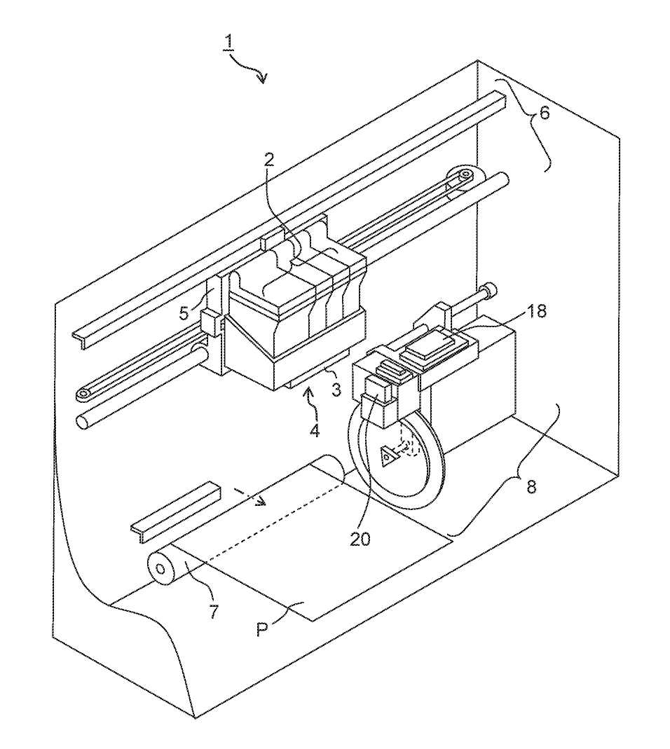

### CROSS REFERENCE TO RELATED APPLICATION

The present application claims priority from Japanese Patent Application No. 2017-071135 filed on Mar. 31, 2017 the disclosure of which is incorporated herein by reference in its entirety.

### BACKGROUND

### Field of the Invention

The present invention relates to a water-based ink for ink-jet recording, and an ink container which accommodates the water-based ink for ink-jet recording therein.

### Description of the Related Art

For the purpose of obtaining a high optical density (OD value) in a case of performing recording on plain paper (plain paper sheet), there is proposed a water-based ink for ink-jet recording (hereinafter referred to also as a “water-based ink” or an “ink” in some cases) using a self-dispersible pigment having a large mean particle diameter (see, for example, Japanese Paten Application Laid-open No. 2004-203903).

In the above-described water-based ink using the self-dispersible pigment having the large mean particle diameter, however, although a high optical density (OD value) can be obtained on the plain paper, the self-dispersible pigment generally has a low fixing property to glossy paper. On the other hand, a water-based ink using a resin-dispersed pigment has a high fixing property to the glossy paper, but has a low optical density (OD value) on the plain paper.

In view of the above-described situation, an object of the present teaching is to provide a water-based ink for ink-jet recording which is capable of realizing both the high optical density (OD value) in a case of performing recording on the plain paper, and the high fixing property to the glossy paper.

### SUMMARY

According to a first aspect of the present teaching, there is provided a water-based ink for ink-jet recording including:

water;

a resin-dispersed pigment; and

a self-dispersible pigment of which mean particle diameter is not less than 130 nm, and is in a range of 1.5 times to 3 times mean particle diameter of the resin-dispersed pigment.

According to a second aspect of the present teaching, there is provided an ink container which accommodates the water-based ink for ink-jet recording of the first aspect therein.

### BRIEF DESCRIPTION OF THE DRAWINGS

The FIGURE is a schematic perspective view depicting the configuration of an example of an ink-jet recording apparatus related to the present teaching.

### DESCRIPTION OF THE EMBODIMENTS

In the present teaching, the term “plain paper” means, for example, recording paper which includes high-quality paper used for a notebook, a writing pad, etc., copying paper having no coating applied thereto, etc., and which has no processing or coating processing performed on a recording surface thereof. The plain paper is exemplified, for example, by “Office Paper” manufactured by FUJITSU LIMITED; “Hammermill Paper Laser Print” manufactured by INTERNATIONAL PAPER COMPANY; “DATA COPY PAPER” manufactured by M-REAL CORPORATION; “Xerox 4200” manufactured by XEROX CORPORATION; “4200DP PAPER” manufactured by FUJI XEROX, LTD.; and the like.

In the present teaching, the term “glossy paper” means recording paper having at least one layer of coating layer formed on a recording surface thereof by using silica particles or alumina particles, etc. The glossy paper is exemplified, for example, by photo glossy paper BP61G, BP71G and BP71GA4 manufactured by BROTHER KOGYO KABUSHIKI KAISHA; ink-jet paper “KASSAI” photo finish gloss pro manufactured by FUJIFILM CORPORATION; top-grade glossy paper PWRA4-20 manufactured by KODAK JAPAN LTD.; and the like.

A water-based ink related to the present teaching will be explained. The water-based ink related to the present teaching contains a colorant and water.

The colorant contains a self-dispersible pigment of which mean particle diameter (average particle size) is not less than 130 nm, and a resin-dispersed pigment. Here, the “mean particle diameter (average particle size)” means an average particle size of secondary particles rather than primary particles. The “secondary particle” means a particle which is formed by an aggregation of the primary particles. This is also applicable to those described later on.

The self-dispersible pigment is dispersible in water without using any dispersing agent, for example, owing to the fact that at least one of the hydrophilic functional group and the salt thereof including, for example, a carbonyl group, a hydroxyl group, a carboxylic acid group, a sulfonic group, and a phosphate group is introduced into the surfaces of the particles of the pigment by the chemical bond directly or with any group intervening therebetween. By using a self-dispersible pigment modified by a phosphate group, it is possible to obtain a particularly high optical density (OD value). As the self-dispersible pigment, it is possible to use a self-dispersible pigment in which the pigment is subjected to a treatment by any one of methods described, for example, in Japanese Patent Application Laid-open No. 8-3498 corresponding to U.S. Pat. No. 5,609,671, Published Japanese Translation of PCT International Publication for Patent Application No. 2000-513396 corresponding to U.S. Pat. No. 5,837,045, Published Japanese Translation of PCT International Publication for Patent Application No. 2008-524400 corresponding to United States Patent Application Publications No. US 2006/0201380, Published Japanese Translation of PCT International Publication for Patent Application No. 2009-515007 corresponding to United States Patent Application Publication No. US 2007/0100023 and United States Patent Application Publications No. US 2007/0100024, Published Japanese Translation of PCT International Publication for Patent Application No. 2011-515535 corresponding to United States Patent Application Publications No. US 2009/0229489, etc. It is possible to use, as a material for the self-dispersible pigment, for example, carbon black, an inorganic pigment, an organic pigment, etc. The carbon black is exemplified, for example, by furnace black, lamp black, acetylene black, channel black, etc. The inorganic pigment is exemplified, for example, by titanium oxide, inorganic pigments based on iron oxide, inorganic pigments based on carbon black, etc. The organic pigment is exemplified, for example, by azo-pigments such as azo lake, insoluble azo-pigment, condensed azo-pigment, chelate azo-pigment, etc.; polycyclic pigments such as phthalocyanine pigment, perylene and perynon pigments, anthraquinone pigment, quinacridone pigment, dioxadine pigment, thioindigo pigment, isoindolinone pigment, quinophthalone pigment etc.; dye lake pigments such as basic dye type lake pigment, acid dye type lake pigment etc.; nitro pigments; nitroso pigments; aniline black daylight fluorescent pigment; and the like. As pigments different from the above-described pigments are exemplified, for example, by C. I. Pigment Blacks 1, 6, and 7; C. I. Pigment Yellows 1, 2, 3, 12, 13, 14, 15, 16, 17, 55, 74, 78, 150, 151, 154, 180, 185, and 194; C. I. Pigment Oranges 31 and 43; C. I. Pigment Reds 2, 3, 5, 6, 7, 12, 15, 16, 48, 48:1, 53:1, 57, 57:1, 112, 122, 123, 139, 144, 146, 149, 166, 168, 175, 176, 177, 178, 184, 185, 190, 202, 221, 222, 224, and 238; C. I. Pigment Violet 19, 196; C. I. Pigment Blues 1, 2, 3, 15, 15:1, 15:2, 15:3, 15:4, 16, 22, and 60; C. I. Pigment Greens 7 and 36; and the like. The carbon black, which is suitable to have the surface treatment performed therefor, includes, for example, carbon blacks such as “MA8”, “MA100” and “#2650” produced by MITSUBISHI CHEMICAL CORPORATION, etc.

As the self-dispersible pigment, it is allowable to use, for example, any commercially available product. The commercially available product includes, for example, “CAB-O-JET (trade name) 200”, “CAB-O-JET (trade name) 250C”, “CAB-O-JET (trade name) 260M”, “CAB-O-JET (trade name) 270Y”, “CAB-O-JET (trade name) 300”, “CAB-O-JET (trade name) 400”, “CAB-O-JET (trade name) 450C”, “CAB-O-JET (trade name) 465M” and “CAB-O-JET (trade name) 470Y” produced by CABOT CORPORATION; “BONJET (trade name) BLACK CW-2”, and “BONJET (trade name) BLACK CW-3” produced by ORIENT CHEMICAL INDUSTRIES, LTD.; and “LIOJET (trade name) WD BLACK 002C” produced by TOYO INK MFG. CO., LTD. It is allowable that only one kind of the self-dispersible pigment as described above is used singly, or two or more kinds of the self-dispersible pigment are used in combination.

As described above, the mean particle diameter (average particle size) of the self-dispersible pigment is not less than 130 nm. The mean particle diameter of the self-dispersible pigment may be, for example, in a range of 130 nm to 200 nm, in a range of 130 nm to 170 nm, or in a range of 150 nm to 170 nm. The mean particle diameter can be calculated, for example, by performing dilution such that the solid content amount is 0.02% by weight and by performing measurement using a dynamic light scattering particle diameter distribution measuring apparatus “LB-550” manufactured by HORIBA, LTD., with the intensity of scattered light as the reference for the mean particle diameter. This is also applicable to those described later on.

The resin-dispersed pigment (resin-dispersible pigment, resin dispersion type pigment) is dispersible in water by, for example, a pigment-dispersing resin (resin dispersant). A pigment which may be used as the resin-dispersed pigment is not particularly limited, and is exemplified, for example, by the above-described pigments which are usable as the material for the self-dispersible pigment such as carbon black, an inorganic pigment, an organic pigment, etc. The carbon black is exemplified, for example, by furnace black, lamp black, acetylene black, channel black, etc. The inorganic pigment is exemplified, for example, by inorganic pigments based on carbon black, etc. The organic pigment is exemplified, for example, by aniline black daylight fluorescent pigment, etc. Further, any pigments different from those listed above can be used, provided that such pigments are dispersible in aqueous phase. Specific examples of the pigment include, for example, C. I. Pigment Blacks 1, 6, and 7, etc. As the resin dispersant, it is allowable to use a general resin dispersant. The resin-dispersed pigment may be encapsulated by the resin dispersant. It is allowable that only one kind of the resin-dispersed pigment as described above is used singly, or two or more kinds of the resin-dispersed pigment are used in combination.

As described above, it is allowable to use, as a the pigment-dispersing resin or the resin for dispersing pigment (resin dispersant), any pigment-dispersing resin of a general type, such as those exemplified by: proteins such as gelatin, albumin, casein, etc.; natural rubbers such as gum arabic, gum traganth, etc.; glucosides such as saponin, etc.; naturally-occurring polymers such as lignin sulfonate, shellac, etc.; anionic polymers such as acrylic acid-acrylic acid ester copolymer and salt thereof, polyacrylate, polymethacrylate, salt of styrene-acrylic acid copolymer, salt of vinylnaphthalene-acrylic acid copolymer, salt of styrene-maleic acid copolymer, salt of maleic acid-maleic anhydride copolymer, salt of vinylnaphthalene-maleic acid copolymer, sodium salt of β-naphthalenesulfonic acid formalin condensate, orthophosphate, etc.; nonionic polymers such as polyvinyl alcohol, polyvinyl pyrrolidone, etc.; and the like.

The blending amount of the pigment-dispersing resin (resin dispersant) with respect to the entire amount of the water-based ink is not particularly limited, and can be determined appropriately in accordance with the kind of the resin-dispersed pigment, the pigment solid content amount of the pigment, etc. The ratio of the solid content weight of the resin dispersant with respect to the pigment solid content weight of the resin-dispersed pigment in the water-based ink is, for example, in a range of 0.10 to 0.60 or in a range of 0.15 to 0.50.

The mean particle diameter (average particle size) of the self-dispersible pigment is in a range of 1.5 times to 3 times the mean particle diameter (average particle size) of the resin-dispersed pigment. The mean particle diameter of the self-dispersible pigment may be, for example, in a range of 1.5 times to 2 times, in a range of 1.5 times to 1.8 times, or in a range of 1.5 times to 1.7 times the mean particle diameter of the resin-dispersed pigment. Further, the difference between the mean particle diameter of the self-dispersible pigment and the mean particle diameter of the resin-dispersed pigment is, for example, not less than 50 nm, in a range of 50 nm to 100 nm, or in a range of 50 nm to 80 nm. The mean particle diameter of the resin-dispersed pigment is, for example, is in a range of 50 nm to 130 nm, in a range of 70 nm to 110 nm, or in a range of 80 nm to 100 nm.

As described above, according to the present teaching, by using the self-dispersible pigment of which mean particle diameter is not less than 130 nm and the resin-dispersed pigment in combination, and making the mean particle diameter of the self-dispersible pigment to be in a range of 1.5 times to 3 times the mean particle diameter of the resin-dispersed pigment, it is possible to realize both the high optical density (OD value) in a case of performing recording on the plain paper, and the high fixing property to the glossy paper. The mechanism for this is presumed, for example, as follows. Namely, in the plain paper, the resin-dispersed pigment also remains on a surface of the plain paper owing to the filling effect by the self-dispersible pigment having the large mean particle diameter, thereby making it possible to obtain a high optical density (OD value). In the glossy paper, concavities and convexities (unevenness, irregularity) generated on a surface of the glossy paper by the self-dispersible pigment having the large mean particle diameter are leveled by the resin-dispersed pigment having the small mean particle diameter, and further the resin-dispersed pigment is wrapped (enveloped) by the resin dispersant, thereby enhancing the fixing property. This mechanism, however, is merely a presumption, and the present teaching is not limited to or restricted by this presumed mechanism.

A ratio (S:R) of a solid content weight (S) of the self-dispersible pigment to a solid content weight (R) of the resin-dispersed pigment in the water-based ink is, for example, in a range of S:R=6:4 to 9:1, or S:R=7:3 to 8:2. In a case that the ratio (S:R) is in the range of 7:3 to 8:2, it is possible to obtain a water-based ink which is more excellent in the balance between the optical density (OD value) when performing recording on the plain paper and the fixing property to the glossy paper. The solid content weight (R) is a weight only of the pigment, and does not include the weight of the resin dispersant. The solid content weight (S) is, for example, in a range of 2.4% by weight to 8.1% by weight, in a range of 3.0% by weight to 7.2% by weight, or in a range of 3.5% by weight to 6.4% by weight. The solid content weight (R) is, for example, in a range of 0.4% by weight to 3.6% by weight, in a range of 0.5% by weight to 3.2% by weight, or in a range of 1.0% by weight to 2.4% by weight.

A sum (S+R) of the solid content weight (S) and the solid content weight (R) is, for example, in a range of 4% by weight to 9% by weight or in a range of 5% by weight to 8% by weight.

The water-based ink may be an achromatic color ink having an achromatic color such as the black color, etc., or may be a chromatic color ink having a chromatic color (color ink). Since the achromatic color ink such as black color ink, etc., is required to have a high optical density (OD value), the achromatic color ink is suitable for the water-based ink related to the present teaching. For example, it is allowable that each of the self-dispersible pigment and the resin-dispersed pigment may be carbon black. It is allowable that the self-dispersible pigment and the resin-dispersed pigment may be pigments of a same kind, or may be pigments of different kinds. Further, it is allowable that the self-dispersible pigment and the resin-dispersed pigment may be pigments of a same color, or may be pigments of different colors.

The water is preferably ion-exchange water or purified water (pure water). The blending amount of the water with respect to the entire amount of the water-based ink may be, for example, a balance of the other components.

The water-based ink may further contain a water-soluble organic solvent. The water-soluble organic solvent is exemplified, for example, by a humectant which prevents the water-based ink from drying at an end of a nozzle in an ink-jet head, a penetrant which adjusts the drying velocity on a recording medium, etc.

The humectant is not particularly limited, and is exemplified, for example, by lower alcohols such as methyl alcohol, ethyl alcohol, n-propyl alcohol, isopropyl alcohol, n-butyl alcohol, sec-butyl alcohol, and tert-butyl alcohol; amides such as dimethylformamide and dimethylacetamide; ketones such as acetone; ketoalcohols (ketone alcohols) such as diacetone alcohol; ethers such as tetrahydrofuran and dioxane; polyethers such as polyalkylene glycol; polyvalent alcohols such as alkylene glycol, glycerol, trimethylolpropane, trimethylolethane, etc.; 2-pyrrolidone; N-methyl-2-pyrrolidone; 1,3-dimethyl-2-imidazolidinone; and the like. The polyalkylene glycol is exemplified, for example, by polyethylene glycol, polypropylene glycol, etc. The alkylene glycol is exemplified, for example, by ethylene glycol, propylene glycol, butylene glycol, diethylene glycol, triethylene glycol, dipropylene glycol, tripropylene glycol, thiodiglycol, hexylene glycol, etc. It is allowable that only one kind of the humectant as described above is used singly, or two or more kinds of the humectant are used in combination. Among the above-described humectants, the humectant is preferably a polyvalent alcohol such as alkylene glycol, glycerol, etc.

The blending amount of the humectant in the entire amount of the water-based ink is, for example, in a range of 0% by weight to 95% by weight, in a range of 5% by weight to 80% by weight, or in a range of 5% by weight to 50% by weight.

The penetrant is not particularly limited, and is exemplified, for example, by glycol ether. The glycol ether is not particularly limited, and is exemplified, for example, by ethylene glycol methyl ether, ethylene glycol ethyl ether, ethylene glycol-n-propyl ether, diethylene glycol methyl ether, diethylene glycol ethyl ether, diethylene glycol-n-propyl ether, diethylene glycol-n-butyl ether, diethylene glycol-n-hexyl ether, triethylene glycol methyl ether, triethylene glycol ethyl ether, triethylene glycol-n-propyl ether, triethylene glycol-n-butyl ether, propylene glycol methyl ether, propylene glycol ethyl ether, propylene glycol-n-propyl ether, propylene glycol-n-butyl ether, dipropylene glycol methyl ether, dipropylene glycol ethyl ether, dipropylene glycol-n-propyl ether, dipropylene glycol-n-butyl ether, tripropylene glycol methyl ether, tripropylene glycol ethyl ether, tripropylene glycol-n-propyl ether, tripropylene glycol-n-butyl ether, etc. One kind of the penetrant may be used singly, or two or more kinds of the penetrant may be used in combination.

The blending amount of the penetrant in the entire amount of the water-based ink may be, for example, in a range of 0% by weight to 20% by weight, in a range of 0% by weight to 15% by weight, or in a range of 1% by weight to 10% by weight.

In a case that the glycol ether is used as the penetrant, and in a case that the blending amount of the glycol ether is too large, there is such a fear that the glycol ether might dissolve the dispersant of the resin-dispersed pigment and might lower the fixing property to the glossy paper.

The water-based ink may further contain an anionic surfactant. The anionic surfactant is exemplified, for example, by alkyl sulfate salt, alkyl sulfate ester salt, alkyl ether sulfate ester salt, alkylbenzene sulfonate, alkyl phosphate, α-olefin sulfonate sodium salt (sodium α-olefin sulfonate), sulfosuccinate, etc. As the anionic surfactant, for example, a commercially available product may be used. The commercially available product is exemplified, for example, by anionic surfactants produced by LION SPECIALTY CHEMICALS CO., LTD., including “LIPOLAN (trade name)” series, “LIPON (trade name)” series, “SUNNOL (trade name)” series, “LIPOTAC (trade name) series, ENAGICOL (trade name)” series, “LIPAL (trade name)” series, and “LOTAT (trade name)” series, etc.; anionic surfactants produced by KAO CORPORATION including “EMAL (trade name)” series, “LATEMUL (trade name)” series, “VENOL (trade name)” series, “NEOPELEX (trade name)” series, NS SOAP, KS SOAP, OS SOAP, and “PELEX (trade name)” series, etc.; anionic surfactants produced by SANYO CHEMICAL INDUSTRIES, LTD. including “SANDET (trade name)” series and “BEAULIGHT (trade name)” series, etc.; anionic surfactants produced by TOHO CHEMICAL INDUSTRY CO., LTD. including “ALSCOPE (trade name)” series, “NEOSCOPE (trade name)” series, “PHOSFANOL (trade name)” series, etc.; sodium hexadecyl sulfate, sodium stearyl sulfate, etc. produced by TOKYO CHEMICAL INDUSTRY CO., LTD.; and the like.

The blending amount of the anionic surfactant in the entire amount of the water-based ink is, for example, not more than 5% by weight, not more than 3% by weight, or in a range of 0.1% by weight to 2% by weight.

The water-based ink may further contain a nonionic surfactant. As the nonionic surfactant, it is allowable to use, for example, a commercially available product. The commercial available product is exemplified, for example, by “OLFIN (trade name) E1010”, “OLFIN (trade name) E1004”, etc., produced by NISSHIN KAGAKU KOGYO KK, etc.

The blending amount of the nonionic surfactant in the entire amount of the water-based ink is, for example, not more than 5% by weight, not more than 3% by weight, or in a range of 0.1% by weight to 2% by weight.

The water-based ink may further contain a resin, in addition to the resin dispersant, for the purpose of improving the fixing property thereof.

The water-based ink may further contain a conventionally known additive, as necessary. The additive is exemplified, for example, by pH-adjusting agents, viscosity-adjusting agents, surface tension-adjusting agents, fungicides, etc. The viscosity-adjusting agents are exemplified, for example, by polyvinyl alcohol, cellulose, etc.

The water-based ink can be prepared, for example, by uniformly mixing the self-dispersible pigment, the resin-dispersed pigment, water, and an optionally other additive(s) as necessary, by a known method, and then removing any non-dissolved matter, etc., with a filter, etc.

The surface tension of the water-based ink is, for example, not less than 30 mN/m. By making the surface tension of the water-based ink to be not less than 30 mN/m, it is possible to suppress any excessive penetration of the water-based ink into the plain paper, thereby making it possible to obtain a higher optical density (OD value) when performing recording on the plain paper. The surface tension of the water-based ink is, for example, not more than 35 mN/m. By making the surface tension of the water-based ink to be not more than 35 mN/m, the spreading of the water-based ink on the glossy paper is promoted, and thus the fixing property to the glossy paper becomes higher. The surface tension is a value, for example, measured at 25° C.

As explained above, according to the present teaching, by using the self-dispersible pigment of which mean particle diameter is not less than 130 nm and the resin-dispersed pigment in combination, and making the mean particle diameter of the self-dispersible pigment to be in a range of 1.5 times to 3 times the mean particle diameter of the resin-dispersed pigment, it is possible to realize both the high optical density (OD value) in a case of performing recording on the plain paper, and the high fixing property to the glossy paper.

Next, an ink cartridge (an example of an ink container) of the present teaching will be explained. The ink cartridge of the present teaching is characterized by being an ink cartridge containing a water-based ink for ink-jet recording; wherein the water-based ink is the water-based ink for ink-jet recording of the present teaching as described above. Namely, the ink cartridge (ink container) related to the present teaching contains the water-based ink for ink-jet recording of the above-described present teaching in the inside thereof. Any known main body (body) of an ink cartridge can be used as the main body of the ink cartridge of the present teaching.

Next, explanation will be given about an ink-jet recording apparatus related to the present teaching.

The ink-jet recording apparatus related to the present teaching is an ink-jet recording apparatus characterized by including: an ink accommodating section configured to accommodate an ink therein; and an ink discharge mechanism configured to discharge the ink accommodated in the ink accommodating section; wherein the ink accommodated in the ink accommodating section is the water-based ink related to the present teaching.

The FIGURE depicts the configuration of an example of the ink-jet recording apparatus related to the present teaching. As depicted in the FIGURE, an ink-jet recording apparatus 1 related to the present teaching includes four ink cartridges (ink containers) 2, an ink discharge mechanism (ink-jet head) 3, a head unit 4, a carriage 5, a driving unit 6, a platen roller 7 and a purge device 8 as main constitutive components or parts.

The four ink cartridges 2 contain water-based inks of four colors, respectively, the four colors being yellow, magenta, cyan and black. For example, the water-based black ink is the water-based ink for ink-jet recording related to the present teaching. In this example, a set of the four ink cartridges 2 is described. However, it is allowable to use an integrated ink cartridge of which interior (inner part) is partitioned so as to form an accommodating section for the water-based yellow ink, an accommodating section for the water-based magenta ink, an accommodating section for the water-based cyan ink and an accommodating section for the water-based black ink, instead of using the set of the four ink cartridges 2. As the body of the ink cartridge, it is possible to use, for example, a publicly known body.

The ink-jet head 3 disposed on the head unit 4 performs recording on a recording medium P (for example, recording paper or recording sheet P such as plain paper, glossy paper, etc.). The four ink cartridges 2 and the head unit 4 are provided or arranged on the carriage 5. The driving unit 6 reciprocates the carriage 5 in a linear direction. As the driving unit 6, it is possible to use, for example, a known driving unit (see, for example, Japanese Patent Application laid-open No. 2008-246821 corresponding to United States Patent Application Publication No. US2008/0241398). The platen roller 7 extends in the reciprocating direction of the carriage 5 and is arranged to face or be opposite to the ink-jet head 3.

The purge device 8 sucks or draws unsatisfactory ink (poor ink) which contains air bubbles, etc. accumulated or trapped in the inside of the ink-jet head 3. As the purge device 8, it is possible to use, for example, a known purge device (see, for example, Japanese Patent Application laid-open No. 2008-246821 corresponding to United States Patent Application Publication No. US2008/0241398).

A wiper member 20 is provided on the purge device 8, at a position on the side of the platen roller 7 such that the wiper member 20 is adjacent to the purge device 8. The wiper member 20 is formed to have a spatula shape, and wipes a nozzle-formed surface of the ink-jet head 3 accompanying with the movement (reciprocating movement) of the carriage 5. In the FIGURE, a cap 18 is provided to cover a plurality of nozzles of the ink-jet head 3 which is returned to a reset position upon completion of the recording, so as to prevent the water-based inks from drying.

In the ink-jet recording apparatus 1 of the present embodiment, the four ink cartridges 2 are provided, together with the head unit 4, on one carriage 5. However, the present teaching is not limited to this. In the ink-jet recording apparatus 1, the respective four ink cartridges 2 may be provided on a carriage which is different (separate) from the carriage on which the head unit 4 is provided. Alternatively, the respective four ink cartridges 2 may be arranged and fixed inside the ink-jet recording apparatus 1, rather than being provided on the carriage 5. In such aspects, for example, each of the four ink cartridges 2 and the head unit 4 which is provided on the carriage 5 are connected with a tube, etc., and the water-based inks are supplied from the four cartridges 2, respectively, to the head unit 4 via the tubes. Further, in these aspects, it is allowable to use, as the ink containers, four ink bottles having a bottle shape, instead of using the four ink cartridges 2. In such a case, each of the ink bottles may be provided with an inlet port via which the ink is poured from the outside to the inside of the ink bottle.

Ink-jet recording using the ink-jet recording apparatus 1 is performed, for example, in the following manner. Namely, at first, a recording paper P is supplied or fed, for example, from a paper feeding cassette or sheet feeding cassette (not depicted in the drawing) arranged at a side of or at a position below the ink-jet recording apparatus 1. The recording paper P is introduced or guided between the ink-jet head 3 and the platen roller 7. Then, a predetermined recording is performed on the fed or introduced recording paper P with the water-based ink(s) discharged or jetted from the ink-jet head 3. The recording paper P after the recording is discharged from the ink-jet recording apparatus 1. According to the present teaching, it is possible to obtain a recorded matter having a high optical density (OD value) in a case of performing recording on the plain paper, and to obtain a recorded matter excellent in the fixing property in a case of performing recording on the glossy paper. In the FIGURE, the paper feeding mechanism and paper discharge mechanism for the recording paper P are omitted in the drawing.

In the apparatus depicted in the FIGURE, an ink-jet head of serial type (serial type ink-jet head) is adopted. However, the present teaching is not limited to this. The ink-jet recording apparatus may be an apparatus adopting an ink-jet head of line type (line type ink-jet head).

The ink-jet recording method of the present teaching is an ink-jet recording method characterized by including: performing recording on a recording medium by discharging, to the recording medium, a water-based ink by an ink-jet system; and using the water-based ink for ink-jet recording related to the present teaching, as the water-based ink. The recording includes printing a letter (text), printing an image, printing, etc.

### EXAMPLES

Next, examples related to the present teaching will be explained together with comparative examples. Note that the present teaching is not limited to and is not restricted by the examples and the comparative examples which will be described below.

<Preparation of Aqueous Pigment Dispersions 1 and 2>

40 g of Carbon Black “#2650” produced by MITSUBISHI CHEMICAL CORPORATION was mixed with 200 g of ion-exchanged water, followed by being pulverized by a bead mill. The pulverized mixture was added with a carboxyl group agent, followed by being heated and agitated, and subjected to an oxidation processing. The obtained liquid was cleaned with a solvent for several times, was poured into water, and was cleaned again with the water in a repeated manner. Then, the liquid was filtrated with a filter, and thus a water (aqueous) pigment dispersion 1 indicated in TABLE 1 was obtained. Further, a water pigment dispersion 2 as indicated in TABLE 1 was obtained in a similar manner regarding the aqueous pigment dispersion 1 except for appropriately changing the component rate and the duration time of dispersing process. The mean particle diameters (sizes) of the carbon blacks contained in the aqueous pigment dispersions 1 and 2, respectively, were measured by using the dynamic light scattering particle diameter distribution measuring apparatus “LB-550” (product name) manufactured by HORIBA, LTD., and the mean particle diameters were 150 nm and 120 nm, respectively.

<Preparation of Aqueous Pigment Dispersions 3 and 4>

Aqueous pigment dispersions 3 and 4 in each of which a pigment was dispersed in water by a dispersant were prepared by the following method. Pure water (purified water) was added to 20% by weight of a pigment (carbon black of which mean particle diameter was 95 nm) and 7% by weight of a styrene-acrylic acid copolymer neutralized by sodium hydroxide (acid value: 175 mgKOH/g, molecular weight: 10000) so that the entire amount thereof was 100% by weight, followed by being agitated and mixed, and thus a mixture was obtained. The obtained mixture was placed in a wet sand mill charged with zirconia beads of which diameter was 0.3 mm, and was subjected to a dispersing process for 6 hours. Afterwards, the zirconia beads were removed by a separator, and the mixture was filtrated through a cellulose acetate filter (pore size 3.00 μm). Thus, an aqueous pigment dispersion 3 indicated in TABLE 1 was obtained. Note that the styrene-acrylic acid copolymer is a water-soluble polymer which is generally used as a dispersant for pigment (pigment dispersant). Further, an aqueous pigment dispersion 4 indicated in TABLE 1 was obtained in a similar manner regarding the aqueous pigment dispersion 3 except for appropriately changing the kind of pigment (mean particle diameter), the component rate and the duration time of dispersing process.

### Examples 1 to 11 and Comparative Examples 1 to 9

Components, except for the aqueous pigment dispersions 1 to 4, which were included in Water-based Ink Composition (TABLE 1) were mixed uniformly or homogeneously; and thus an ink solvent was obtained. Subsequently, the ink solvent was added to each of the aqueous pigment dispersions 1 to 4, followed by being mixed uniformly, and thus a mixture was obtained. After that, the obtained mixture was filtrated through a cellulose acetate membrane filter (pore size 3.00 μm) produced by TOYO ROSHI KAISHA, LTD., and thus a water-based ink for ink jet recording of each of Examples 1 to 11 and Comparative Examples 1 to 9 indicated in TABLE 1 were obtained. Note that in TABLE 1, the ratio between the mean particle diameters indicates as to the mean particle diameter of the self-dispersible pigment is which times the mean particle diameter of the resin-dispersed pigment; the surface tension of the water-based ink is a value which was measured at 25° C. by using a surface tensiometer model name: CBVP-Z manufactured by KYOWA INTERFACE SCIENCE CO., LTD.

With respect to the water-based inks of Examples 1 to 11 and Comparative Examples 1 to 9, respectively, (a) Evaluation of the optical density (OD value) in plain paper and (b) Evaluation of the fixing property to glossy paper were performed by the following methods.

(a) Evaluation of the Optical Density (OD Value) in Plain Paper

An ink-jet printer “MFC-J4510” manufactured by BROTHER KOGYO KABUSHIKI KAISHA was used to record an image on a plain paper (“Office Paper” manufactured by FUJITSU LIMITED) by using each of the water-based inks of Examples 1 to 11 and Comparative Examples 1 to 9. Thus, evaluation samples were produced. The optical density (OD value) was measured at three locations (portions) in each of the evaluation samples by using a spectrophotometric colorimetry meter “SpectroEye” (light source: D₅₀; field: 2°; density reference: ANSI-T) manufactured by X-RITE INC., and an average value of the optical density in the three locations was obtained. Further, the optical density (OD value) in the plain paper was evaluated according to the following evaluation criterion.

<Criterion for Evaluation of Optical Density (OD Value) in Plain Paper>

A: The optical density (OD value) was not less than 1.09.

B: The optical density (OD value) was in a range of not less than 1.02 to less than 1.09.

C: The optical density (OD value) was less than 1.02.

(b) Evaluation of the Fixing Property to Glossy Paper

The ink-jet printer “MFC-J4510” was used to record an image on a glossy paper (“BP71G” manufactured by BROTHER KOGYO KABUSHIKI KAISHA) by using each of the water-based inks of Examples 1 to 11 and Comparative Examples 1 to 9. Thus, evaluation samples were produced. The evaluation samples were used to evaluate the fixing property to the glossy paper according to the following evaluation criterion.

<Criterion for Evaluation of Fixing Property to Glossy Paper>

AA: Any dirtied portion (smudge) was not generated in a case that the evaluation sample was rubbed after 3 minutes since the recording.

A: Although a dirtied portion (smudge) was generated in a case that the evaluation sample was rubbed after 3 minutes since the recording, any dirtied portion (smudge) was not generated in a case that the evaluation sample was rubbed after 10 minutes since the recording.

B: Although a dirtied portion (smudge) was generated in a case that the evaluation sample was rubbed after 10 minutes since the recording, any dirtied portion (smudge) was not generated in a case that the evaluation sample was rubbed after 1 hour since the recording.

C: A dirtied portion (smudge) was generated in a case that the evaluation sample was rubbed even after 1 hour since the recording.

The water-based ink composition and the results of evaluations of each of the water-based inks of Examples 1 to 11 and Comparative Examples 1 to 9 are indicated in TABLE 1.

TABLE 1

| | | EXAMPLES | | | | | |
|---|---|---|---|---|---|---|---|
| | | 1 | 2 | 3 | 4 | 5 | 6 |
| Water- | Aqueous pigment dispersion 1 (S) (*1) | 4 | 3.5 | 3.5 | 4 | 4 | 4.5 |
| based | Aqueous pigment dispersion 2 (S) (*2) | — | — | — | — | — | — |
| Ink | Aqueous pigment dispersion 3 (R) (*3) | 1 | 1.5 | 1.5 | 1 | 1 | 0.5 |
| Composition | Aqueous pigment dispersion 4 (R) (*4) | — | — | — | — | — | — |
| (% by | JONCRYL (trade name) 60 (*5) | — | — | 0.3 | — | — | — |
| weight) | JONCRYL (trade name) 537 (*6) | — | — | — | — | — | — |
| | Glycerol | 28 | 28 | 26 | — | 26 | 28 |
| | Triethylene glycol | — | — | — | 30 | — | — |
| | Triethylene glycol-n-butyl ether | 5 | 5 | 5 | 5 | 5 | 5 |
| | OLFIN (trade name) E1010 (*7) | 0.3 | 0.3 | 0.3 | 0.3 | — | 0.3 |
| | OLFIN (trade name) E1004 (*8) | — | — | — | — | 0.1 | — |
| | Water | balance | balance | balance | balance | balance | balance |

| | | | | | | |
|---|---|---|---|---|---|---|
| S:R | 8:2 | 7:3 | 7:3 | 8:2 | 8:2 | 9:1 |
| Ratio between mean particle diameters (x times) | 1.6 | 1.6 | 1.6 | 1.6 | 1.6 | 1.6 |
| Surface tension (mN/m) | 33 | 33 | 33 | 33 | 31 | 33 |
| Evaluation of optical density (OD value) in plain paper | A | A | A | A | A | A |
| Evaluation of fixing property with respect to glossy paper | A | A | A | A | A | B |

| | | EXAMPLES | | | | |
|---|---|---|---|---|---|---|
| | | 7 | 8 | 9 | 10 | 11 |
| Water- | Aqueous pigment dispersion 1 (S) (*1) | 3 | 4 | 4 | 4 | 6 |
| based | Aqueous pigment dispersion 2 (S) (*2) | — | — | — | — | — |
| Ink | Aqueous pigment dispersion 3 (R) (*3) | 2 | 1 | 1 | 1 | 2 |
| Composition | Aqueous pigment dispersion 4 (R) (*4) | — | — | — | — | — |
| (% by | JONCRYL (trade name) 60 (*5) | — | — | — | — | — |
| weight) | JONCRYL (trade name) 537 (*6) | — | — | — | — | — |
| | Glycerol | 28 | 26 | 26 | 26 | 22 |
| | Triethylene glycol | — | — | — | — | — |
| | Triethylene glycol-n-butyl ether | 5 | 5 | 5 | 5 | 5 |
| | OLFIN (trade name) E1010 (*7) | 0.3 | 1 | — | — | 0.3 |
| | OLFIN (trade name) E1004 (*8) | — | — | 0.3 | — | — |
| | Water | balance | balance | balance | balance | balance |

| | | | | | |
|---|---|---|---|---|---|
| S:R | 6:4 | 8:2 | 8:2 | 8:2 | 7.5:2.5 |
| Ratio between mean particle diameters (x times) | 1.6 | 1.6 | 1.6 | 1.6 | 1.6 |
| Surface tension (mN/m) | 33 | 29 | 29 | 36 | 33 |
| Evaluation of optical density (OD value) in plain paper | B | B | B | A | A |
| Evaluation of fixing property with respect to glossy paper | A | A | A | B | A |

| | | COMPARATIVE EXAMPLES | | | | | | | | |
|---|---|---|---|---|---|---|---|---|---|---|
| | | 1 | 2 | 3 | 4 | 5 | 6 | 7 | 8 | 9 |
| Water- | Aqueous pigment dispersion 1 (S) (*1) | 5 | 5 | 5 | 5 | 8 | 8 | — | — | 3.5 |
| based | Aqueous pigment dispersion 2 (S) (*2) | — | — | — | — | — | — | — | 3.5 | — |
| Ink | Aqueous pigment dispersion 3 (R) (*3) | — | — | — | — | — | — | 5 | 1.5 | — |
| Composition | Aqueous pigment dispersion 4 (R) (*4) | — | — | — | — | — | — | — | — | 1.5 |
| (% by | JONCRYL (trade name) 60 (*5) | — | 0.3 | — | 1.0 | 1.0 | 3.0 | — | — | — |
| weight) | JONCRYL (trade name) 537 (*6) | — | — | 0.3 | — | — | — | — | — | — |
| | Glycerol | 27 | 27 | 27 | 21 | 21 | 18 | 28 | 28 | 28 |
| | Triethylene glycol | — | — | — | — | — | — | — | — | — |
| | Triethylene glycol-n-butyl ether | 5 | 5 | 5 | 5 | 5 | 5 | 5 | 5 | 5 |
| | OLFIN (trade name) E1010 (*7) | 0.3 | 0.3 | 0.3 | 0.3 | 0.3 | 0.3 | 0.3 | 0.3 | 0.3 |
| | OLFIN (trade name) E1004 (*8) | — | — | — | — | — | — | — | — | — |
| | Water | balance | balance | balance | balance | balance | balance | balance | balance | balance |

| | | | | | | | | | |
|---|---|---|---|---|---|---|---|---|---|
| S:R | — | — | — | — | — | — | — | 7:3 | 7:3 |
| Ratio between mean particle diameters (x times) | — | — | — | — | — | — | — | 1.3 | 1.2 |
| Surface tension (mN/m) | 33 | 33 | 33 | 33 | 33 | 33 | 33 | 33 | 33 |
| Evaluation of optical density (OD value) in plain paper | A | A | A | C | Not | Not | C | C | A |
| Evaluation of fixing property with respect to glossy paper | C | C | C | B | available | available | AA | B | C |

TABLE 1 (following) - LEGEND
(*1): Aqueous dispersion of self-dispersible carbon black; mean particle diameter: 150 nm; numeral in the table indicates pigment solid content weight.
(*2): Aqueous dispersion of self-dispersible carbon black; mean particle diameter: 120 nm; numeral in the table indicates pigment solid content weight.
(*3): Aqueous dispersion of carbon black (containing resin dispersant); mean particle diameter: 95 nm; numeral in the table indicates pigment solid content weight.
(*4): Aqueous dispersion of carbon black (containing resin dispersant); mean particle diameter: 130 nm; numeral in the table indicates pigment solid content weight.
(*5): Resin solution; manufactured by BASF SE (former JOHNSON POLYMER CO., LTD.); numeral in the table indicates solid content weight.
(*6): Resin solution; manufactured by BASF SE (former JOHNSON POLYMER CO., LTD.); numeral in the table indicates solid content weight.
(*7): Surfactant, manufactured by NISSHIN KAGAKU KOGYO KK; numeral in the table indicates effective ingredient amount.
(*8): Surfactant, manufactured by NISSHIN KAGAKU KOGYO KK; numeral in the table indicates effective ingredient content amount.

As indicated in TABLE 1, in Examples 1 to 11, the result of evaluation of optical density (OD value) in the plain paper and the result of evaluation of fixing property to the glossy paper were satisfactory. In particular, Examples 1 and 2, each satisfying S:R=7:3 to 8:2, were more excellent in the balance between the optical density (OD value) in the plain paper and the fixing property to the glossy paper, than Examples 6 and 7 each having a similar condition (composition) to that of Examples 1 and 2 except for the S:R being S:R=9:1 and S:R=6:4, respectively. Further, Example 5 having the surface tension of 31 mN/m was more excellent in the optical density (OD value) in the plain paper than Examples 8 and 9 each having the surface tension of 29 mN/m due to the change in the blending amount of the surfactant added thereto; and Example 5 having the surface tension of 31 mN/m was more excellent in the fixing property to the glossy paper than in Example 10 having the surface tension of 36 mN/m due to the change in the blending amount of the surfactant added thereto.

On the other hand, in Comparative Examples 1 to 3 each not using the resin-dispersed pigment, the result of evaluation of the fixing property to the glossy paper was unsatisfactory. In Comparative Examples 4 to 6 each not using the resin-dispersed pigment, the blending amount of the resin (JONCRYL (trade name)) was increased for the purposed of improving the fixing property to the glossy paper, than those in Comparative Examples 1 to 3. However, in Comparative Example 4, the result of evaluation of the optical density (OD value) in the plain paper was unsatisfactory; in Comparative Examples 5 and 6, the evaluations could not be performed due to the increased viscosity and aggregation. Further, in Comparative Example 7 not using the self-dispersible pigment, the result of evaluation of the optical density (OD value) in the plain paper was unsatisfactory. Furthermore, in Comparative Example 8 in which the mean particle diameter of the self-dispersible pigment was less than 130 nm, the result of evaluation of the optical density (OD value) in the plain paper was unsatisfactory. Moreover, in Comparative Example 9 in which the mean particle diameter of the self-dispersible pigment was less than 1.5 times the mean particle diameter of the resin-dispersed pigment, the result of evaluation of the fixing property to the glossy paper was unsatisfactory.

As described above, the water-based ink related to the present teaching is capable of realizing both the high optical density (OD value) in the case of performing recording on the plain paper, and the high fixing property to the glossy paper. The applicability of the water-based ink related to the present teaching is not particularly limited, and is widely applicable to a variety of kinds of ink-jet recording.

What is claimed is:

1. A water-based ink for ink-jet recording comprising:
water;
a resin-dispersed pigment; and
a self-dispersible pigment of which mean particle diameter is not less than 130 nm, and is in a range of 1.5 times to 3 times mean particle diameter of the resin-dispersed pigment.

2. The water-based ink for ink-jet recording according to claim 1, wherein a ratio (S:R) of a solid content weight (S) of the self-dispersible pigment to a solid content weight (R) of the resin-dispersed pigment in the water-based ink is in a range of 6:4 to 9:1.

3. The water-based ink for ink-jet recording according to claim 1, wherein a ratio (S:R) of a solid content weight (S) of the self-dispersible pigment to a solid content weight (R) of the resin-dispersed pigment in the water-based ink is in a range of 7:3 to 8:2.

4. The water-based ink for ink-jet recording according to claim 1, wherein a sum (S+R) of a solid content weight (S) of the self-dispersible pigment and a solid content weight (R) of the resin-dispersed pigment in the water-based ink is in a range of 4% by weight to 9% by weight.

5. The water-based ink for ink-jet recording according to claim 1, wherein surface tension of the water-based ink is not less than 30 mN/m.

6. The water-based ink for ink-jet recording according to claim 1, wherein surface tension of the water-based ink is not more than 35 mN/m.

7. The water-based ink for ink-jet recording according to claim 1, wherein difference between the mean particle diameter of the self-dispersible pigment and the mean particle diameter of the resin-dispersed pigment is not less than 50 nm.

8. The water-based ink for ink-jet recording according to claim 1, wherein each of the self-dispersible pigment and the resin-dispersed pigment is carbon black.

9. The water-based ink for ink-jet recording according to claim 1, further comprising triethylene glycol-n-butyl ether.

10. The water-based ink for ink-jet recording according to claim 1, wherein the mean particle diameter of the self-dispersible pigment is in a range of 1.5 times to 2 times the mean particle diameter of the resin-dispersed pigment.

11. The water-based ink for ink-jet recording according to claim 1, wherein the mean particle diameter of the self-dispersible pigment is in a range of 1.5 times to 1.7 times the mean particle diameter of the resin-dispersed pigment.

12. The water-based ink for ink-jet recording according to claim 1, wherein the mean particle diameter of the self-dispersible pigment is in a range of 130 nm to 200 nm.

13. The water-based ink for ink-jet recording according to claim 1, wherein the mean particle diameter of the self-dispersible pigment is in a range of 150 nm to 170 nm.

14. The water-based ink for ink-jet recording according to claim 1, wherein the mean particle diameter of the self-dispersible pigment is in a range of 150 nm to 170 nm, and is in a range of 1.5 times to 1.7 times the mean particle diameter of the resin-dispersed pigment.

15. An ink container which accommodates the water-based ink for ink-jet recording as defined in claim 1.
